(19) United States
(12) Patent Application Publication
(10) Pub. No.: US 2026/0275945 A1
(43) Pub. Date: Sep. 17, 2026

(54) VARIABLE AIR FUNNEL APPARATUS

(71) Applicant: Honda Motor Co., Ltd., Tokyo (JP)

(72) Inventors: Toshihiro KUBO, Tokyo (JP); Ryosuke YAMAZAKI, Tokyo (JP)

(73) Assignee: Honda Motor Co., Ltd., Tokyo (JP)

(21) Appl. No.: 19/447,729

(22) Filed: Jan. 13, 2026

(30) Foreign Application Priority Data
Mar. 12, 2025 (JP) 2025-039802

(51) Int. Cl. F02M 35/10; F02M 35/02

(52) U.S. Cl. CPC F02M 35/10262; F02M 35/0204; F02M 35/10118; F02M 35/10144

(57) ABSTRACT

When movable funnels are in a coupled position being coupled to fixed funnels, all of variable air funnels are equal in effective funnel channel length. When the movable funnels are in a separated position where they are separated from the fixed funnels, at least one of the fixed funnels is different from the other fixed funnels in height of their upstream-end openings, and at least one of the variable air funnels is different from the other variable air funnels in effective funnel channel length.

### BACKGROUND

### 1. Technical Field

The present invention relates to a variable air funnel apparatus with a plurality of variable air funnels that are capable of varying the intake passage length of each intake passage of a multi-cylinder internal combustion engine installed in a vehicle.

### 2. Description of the Background

There is an exemplary variable air funnel apparatus (see, for example, Patent Literature 1) that includes variable air funnels including: fixed funnels connected to the intake ports of an internal combustion engine; and movable funnels shifting to be brought into contact with or away from the upstream side of the fixed funnels. The movable funnels are shifted according to the speed of the internal combustion engine to change the effective funnel channel length of the variable air funnels that work as part of the intake passage. The variable air funnel apparatus is intended to optimize the output characteristics of the internal combustion engine by varying the intake passage length.

### CITATION LIST

### PATENT LITERATURE

Patent Literature 1: JP 2022-146821 A

The variable air funnel apparatus disclosed in Patent Literature 1 is a variable air funnel apparatus provided at the intake passage of an inline-four engine, including four variable air funnels arranged in parallel. In the variable air funnels, four fixed funnels coupled to the intake ports of the four cylinders, respectively, are arranged in parallel in the vehicle width direction, and movable funnels are disposed above the four fixed funnels, respectively, to shift in the central axis direction of the fixed funnels.

Above the four fixed funnels being equal in channel length, the four movable funnels being equal in channel length are arranged corresponding to the fixed funnels, respectively. The four movable funnels shift together to be coupled to and separated from their respective fixed funnels.

When the movable funnels are coupled to the fixed funnels, the effective funnel channel length of the variable air funnels, as well as their intake passage length, becomes longer. When the movable funnels are separated from the fixed funnels, the effective funnel channel length of the variable air funnels, as well as their intake passage length, becomes shorter because the effective funnel channel length becomes the channel length of the fixed funnels.

In a lower engine speed range, the effective funnel channel length is increased; in a higher engine speed range, the effective funnel channel length is reduced. Thus, the apparatus attempts to exhibit high torque performance across the entire range of engine speeds.

### BRIEF SUMMARY

In the variable air funnels arranged in parallel in Patent Literature 1, when the movable funnels are in the separated position, the upstream-side opening ends (upper ends) of the four fixed funnels taking in air are at the same height, which is a relatively low position in the air cleaner case. When the movable funnels are in the coupled position, the upstream-side opening ends (upper ends) of the four movable funnels taking in air are at the same height, which is a relatively high position in the air cleaner case.

In a higher engine speed range, the highest possible intake efficiency is required to obtain a high output of the internal combustion engine.

In Patent Literature 1, in a higher engine speed range, the movable funnels are in the separated position, and the upstream-side opening ends (upper ends) of the four fixed funnels taking in air are all at a relatively low height position in the air cleaner case. Therefore, the air intake height is limited to a relatively low position, making it difficult to further improve intake efficiency.

Furthermore, since the upstream-side opening ends (upper ends) of the four fixed funnels are all at the same height in the air cleaner case, they are substantially equal in intake passage length with a slight variation in the output characteristic, which may result in vibrations and acoustic resonance.

The present invention has been made in view of the foregoing, and an object thereof is to provide a variable air funnel apparatus with improved intake efficiency in a higher engine speed range to achieve a higher output while reducing vibrations and acoustic resonance.

To attain the above object, the present invention provides a variable air funnel apparatus including variable air funnels arranged to be juxtaposed to each other, the variable air funnels including fixed funnels connected to a plurality of intake ports of an internal combustion engine installed in a vehicle, respectively, and movable funnels disposed above the fixed funnels to shift in a central axis direction of the fixed funnels, respectively.

The arranged movable funnels have a separated position where the movable funnels shift together upward in the central axis direction of the fixed funnels to be separated from the fixed funnels, and a coupled position where the movable funnels shift together downward in the central axis direction of the fixed funnels to be coupled to the fixed funnels.

The variable air funnels have a variable intake passage length in which an effective funnel channel length is increased by the movable funnels shifting to the coupled position, and the effective funnel channel length is reduced by the movable funnels shifting to the separated position.

When the movable funnels are in the coupled position, all of the variable air funnels are equal in effective funnel channel length.

When the movable funnels are in the separated position, at least one of the fixed funnels is different from the other fixed funnels in height of their upstream-end openings, and at least one of the variable air funnels is different in effective funnel channel length from the other variable air funnels.

According to this configuration, when the movable funnels are in the separated position separated from the fixed funnels, at least one of the fixed funnels is different from the other fixed funnels in height of their upstream-end openings, and at least one of the effective funnel channel lengths is different from the other effective funnel channel lengths. Accordingly, when the movable funnels are in the separated position, there are fixed funnels having their upstream-end openings taking in air positioned higher and the fixed funnels having their upstream-end openings positioned lower. These fixed funnels, differing in the height of upstream-end openings, efficiently take in air from different height layers in the air cleaner case. This further improves intake efficiency. A higher output is expected with a higher engine speed range where the movable funnels are in the separated position.

When the movable funnels are in the separated position, at least one of the effective funnel channel lengths is different from the other effective funnel channel lengths. The different intake passage lengths provide varied output characteristics and reduce vibrations and acoustic resonance.

In the above configuration, adjacent ones of the movable funnels are integrally coupled to each other by a coupling part formed at a site where the adjacent movable funnels become close to each other.

Drive of an actuator acts on the coupling part to integrally shift the coupled movable funnels.

According to this configuration, the coupling part is at the site where the adjacent movable funnels become close to each other. The drive of the actuator acts on the coupling part, whereby the adjacent movable funnels integrally shift. Thus, the drive of the actuator acts on the coupling part positioned at substantially the center of the adjacent movable funnels. The integrally coupled movable funnels are less prone to having deformations such as distortion, deflection, or twist. The movable funnels can integrally shift smoothly without friction. The movable funnels can closely sit on their respective fixed funnels.

When three or more movable funnels are coupled, they become elongated as a whole in the parallel direction, increasing the risk of distortion or twist when shifting. For a plurality of movable funnels to closely sit together on the fixed funnels, tolerances must be kept small, and therefore, mass production is difficult. On the other hand, the movable funnels of just two pieces coupled to each other can closely sit together on the fixed funnels with improved accuracy, even if the tolerances are standard.

In the above configuration, the movable funnels each have a tapered part.

The coupling part is provided at the tapered parts.

According to this configuration, the coupling part is provided at the tapered parts of the movable funnels. Since the coupling part is accommodated in the space formed by the tapered parts of the adjacent movable funnels, the adjacent movable funnels can be coupled close to each other. This contributes to reducing the size of the variable air funnel apparatus.

In the above configuration, the fixed funnels retain guide shafts oriented in their central axis direction to oppose the coupling parts.

The movable funnels slidably engage with and are guided by the guide shafts in shifting.

According to this configuration, the fixed funnels retain the guide shafts oriented in their central axis direction to oppose the coupling part of the adjacent movable funnels. The movable funnels slidably engage with and are guided by the guide shafts in shifting. Accordingly, the drive of the actuator is effectively transferred to the shifting of the movable funnels via the coupling part to shift the movable funnels smoothly.

The adjacent movable funnels coupled by the coupling part slidably engage with the guide shaft that opposes the coupling part. The adjacent movable funnels are integrally coupled by the coupling part and the engaging part that slidably engages with the guide shafts, and exhibit high rigidity.

In the above configuration, out of the fixed funnels arranged in parallel in a vehicle width direction, outermost fixed funnels retain second guide shafts, separately from first guide shafts being the guide shafts, at positions inner than outermost parts of the fixed funnels.

The outermost movable funnels slidably engage with and are guided by the second guide shafts in shifting.

According to this configuration, since the configuration includes, separately from the first guide shafts, the second guide shafts that slidably engage with and guide the outermost movable funnels, the movable funnels are shifted more smoothly.

The second guide shafts are retained by the fixed funnels at positions inner than the outermost parts of the outermost fixed funnels. This allows the second guide shafts to be set on the inner side in the arrangement direction width of the fixed funnels arranged in parallel, contributing to reducing the size of the variable air funnel apparatus.

In the above configuration, the movable funnels are smaller in outer diameter than the fixed funnels.

The second guide shafts are positioned inner than the outermost parts of the outermost movable funnels.

According to this configuration, the second guide shafts are positioned inner than the outermost parts of the outermost movable funnels that are smaller in outer diameter than the fixed funnels. This allows the second guide shafts to be set on the inner side in the arrangement direction width of the movable funnels arranged in parallel, further contributing to reducing the size of the variable air funnel apparatus.

In the above configuration, the outermost fixed funnels support lower ends of pillars that stand upright outer in the vehicle width direction than the first guide shafts.

A rotary shaft rotated by the actuator is horizontally and rotatably suspended between upper ends of a pair of the pillars at a higher position than the fixed funnels.

An arm member has its basal end fixed to the rotary shaft on an inner side of the pair of pillars in the vehicle width direction, and has its tip engaged with the coupling part.

According to this configuration, the rotary shaft rotated by the actuator is rotatably and horizontally suspended between the upper ends of a pair of pillars at a higher position than the fixed funnels. The arm member having its basal end fixed to the rotary shaft has its tip engaged with the coupling part. Accordingly, when the rotary shaft is rotated by the actuator, the arm member having its basal end fixed to the rotary shaft swings, and the movable funnels are shifted via the coupling part engaging with the swinging arm member.

The guide shafts with which the movable funnels slidably engage and the arm member that acts on the coupling part to shift the movable funnels are positioned on the inner side of a pair of pillars in the vehicle width direction. Accordingly, when the movable funnels shift due to the swing of the arm member, the rotary shaft becomes less prone to having problems such as deflection. Power is transferred effectively.

The central fixed funnels are on the inner side of the pair of pillars in the vehicle width direction and positioned lower than the rotary shaft. This contributes to reducing the size of the variable air funnel apparatus.

In the above configuration, the pair of pillars is positioned inner than the pair of second guide shafts in the vehicle width direction.

According to this configuration, a pair of pillars is positioned inner than a pair of second guide shafts in the vehicle width direction. This contributes to reducing the size of the variable air funnel apparatus. The outermost movable funnels become less prone to oscillating when shifting by being guided by the second guide shafts.

In the above configuration, in an air cleaner case having its inside divided into a clean side and a dirty side by an air filter, the variable air funnels are provided on the clean side.

The first guide shafts, the second guide shafts, and the rotary shaft are disposed on the side opposite to the air filter relative to the variable air funnels.

According to this configuration, the intake airflow taken from the air filter into the fixed funnels or the movable funnels flows smoothly without any interference with the first guide shafts, the second guide shafts, and the rotary shaft, avoiding a reduction in intake efficiency.

In the above configuration, the second guide shafts are each disposed on an inner side of a corner of lateral walls of the air cleaner case.

According to this configuration, the second guide shafts are disposed in the unused space on the inner side of the corners of the lateral walls of the air cleaner case. The efficient use of the space contributes to reducing the size of the air cleaner case.

In the above configuration, the air cleaner case is structured by a combination of an upper air cleaner case and a lower air cleaner case.

Upper ends of the second guide shafts are retained by the upper air cleaner case.

According to this configuration, the upper ends of the second guide shafts are retained by the upper air cleaner case. This suppresses any oscillation or warpage of the second guide shafts and allows the movable funnels to shift smoothly.

In the above configuration, the air filter is tilted, having its upper surface oriented toward the variable air funnels.

The air filter is made up of two upper and lower units of an upper air filter and a lower air filter.

A lower side of the upper air filter is substantially at a same height as the upstream-end openings of the fixed funnels having their upstream-end openings at a higher position.

A lower side of the lower air filter is substantially at a same height as the upstream-end openings of the fixed funnels having their upstream-end openings at a lower position.

According to this configuration, the air filter is tilted, having its upper surface oriented toward the variable air funnels. The lower side of the upper air filter at a higher position is substantially at the same height as the upstream-end openings of the fixed funnels, whose upstream-end openings are at a higher position. The lower side of the lower air filter at a lower position is substantially at the same height as the upstream-end openings of the fixed funnels, whose upstream-end openings are at a lower position. Accordingly, when the movable funnels are in the separated position, the upper layer air, having passed through the upper air filter, is taken into the fixed funnels having their upstream-end openings at a higher position, and the lower layer air, having passed through the lower air filter, is taken into the fixed funnels having their upstream-end openings at a lower position.

That is, air from different height layers in the air cleaner case is efficiently taken into the fixed funnels having the upstream-end openings of different heights. This further contributes to improving intake efficiency, and a higher output is expected with a higher engine speed range where the movable funnels are in the separated position.

In the above configuration, out of the fixed funnels arranged in parallel, central fixed funnels are higher than outer fixed funnels in height of their upstream-end openings.

The lower air filter is larger than the upper air filter in right-left width in the vehicle width direction.

According to this configuration, out of the fixed funnels arranged in parallel, the central fixed funnels are higher than the outer fixed funnels in height of their upstream-end openings. The lower air filter at a lower position is larger in right-left width. This facilitates the air having passed through the right and left sides of the lower air filter to be taken into the upstream-end openings of the outer fixed funnels having the upstream-end openings at a lower position, improving intake efficiency.

The air having passed through the upper air filter is taken into the upstream-end openings of the central fixed funnels having their upstream-end openings at a higher position.

Accordingly, the central fixed funnels, having their upstream-end openings at a higher position, and the outer fixed funnels, having their upstream-end openings at a lower position, can separately cover the upper and lower positions in the air filter, thereby improving intake efficiency.

In the above configuration, the upper air cleaner case has an air guiding shape that guides air having passed through the air filter to the upstream-end openings of the movable funnels in the separated position.

According to this configuration, in the ceiling surface of the upper air cleaner case, the air guiding shape that guides the air having passed through the air filter to the upstream-end openings of the movable funnel in the separated position is formed. Accordingly, the air guided by the air guiding shape of the ceiling surface of the upper air cleaner case flows into the upstream-end openings of the movable funnel in the separated position. The air having passed through the movable funnels joins the intake flow taken into the upstream-end openings of the fixed funnels. This further improves intake efficiency when the movable funnels are separated.

In the present invention, when the movable funnels are in the coupled position, all of the variable air funnels are equal in effective funnel channel length. When the movable funnels are in the separated position where they are separated from the fixed funnels, at least one of the variable air funnels is different in effective funnel channel length from the other variable air funnels. Accordingly, when the movable funnels, each forming an effective funnel channel length, are in the separated position, some upstream-side opening ends of the fixed funnels for taking in air belong to the fixed funnels positioned higher in the air cleaner case, and the others belong to the fixed funnels positioned lower. This makes it possible to take in air from different height layers in the air cleaner case, and further contributes to improving intake efficiency with a higher engine speed range where the movable funnels are in the separated position.

Furthermore, when the movable funnels are in the separated position, at least one of the effective funnel channel lengths is different from the other effective funnel channel lengths. Thus, the movable funnels of different intake passage lengths provide varied output characteristics and reduce vibrations and acoustic resonance.

### BRIEF DESCRIPTION OF DRAWINGS

FIG. 1 is an entire side view of a motorcycle equipped with an internal combustion engine having a variable air funnel apparatus according to one embodiment of the present invention.

FIG. 2 is a top view of a lower air cleaner case and its internal structure.

FIG. 3 is a perspective view of an upper air cleaner case as seen from the back side.

FIG. 4 is an overall perspective view of variable air funnels arranged in parallel.

FIG. 5 is a sectional side view of the air cleaner case and its internal structure when movable funnels are in a separated position.

FIG. 6 is a sectional side view of the air cleaner case and its internal structure when the movable funnels are in a coupled position.

FIG. 7 is a rear view of the variable air funnels when the movable funnels are in the separated position.

FIG. 8 is a front view of the variable air funnels when the movable funnels are in the separated position.

FIG. 9 is a front view of the variable air funnels when the movable funnels are in the coupled position.

FIG. 10 is a perspective view of the movable funnels coupled to each other by first coupling parts and second coupling parts.

FIG. 11 is a rear view of the movable funnels coupled to each other.

FIG. 12 is a top view of the movable funnels coupled to each other.

FIG. 13 is an enlarged view of the substantial part of an arm member, the coupling part, and their surroundings.

FIG. 14 is a sectional side view of the arm member and the coupling part.

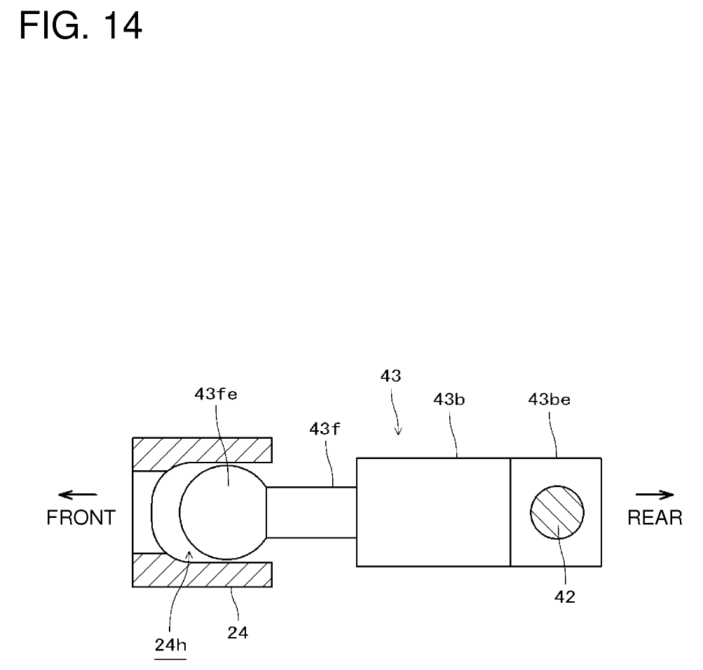

FIG. 15 is a side view of a variable air funnel apparatus using movable funnels according to a variation disposed in an air cleaner case.

FIG. 16 is a perspective view of the movable funnels coupled to each other by a first coupling part and a second coupling part.

### DETAILED DESCRIPTION

In the following, an embodiment of the present invention will be described referring to the drawings.

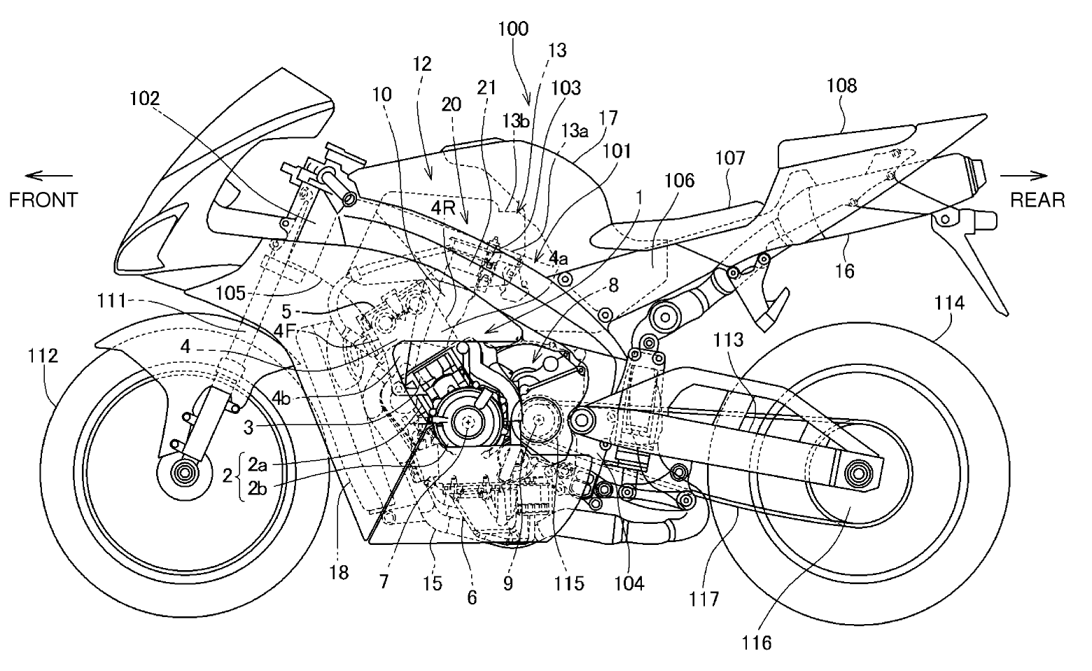

FIG. 1 is an entire left side view of a motorcycle 100 equipped with an internal combustion engine 1 to which a variable air funnel apparatus according to an embodiment of the present invention is applied.

In the description, the front, rear, right, and left directions will follow the normal vehicle standards, with the straight-ahead direction of the motorcycle 100 being the forward direction.

The top-bottom direction of the variable air funnel structure will be described, having the upstream side of the intake upstream side as the top, and the downstream side as the bottom, relative to a central axis L of variable air funnels.

As shown in FIG. 1, a body frame 101 of the motorcycle 100 includes: a head pipe 102 that steerably receives front forks 111 pivotally holding a front wheel 112; a pair of right and left main frames 103 extending rearward downward from the head pipe 102; a pair of right and left engine hangers 105 that is connected to the head pipe 102 and the front of the right and left main frames 103 to extend rearward downward below the main frames 103; a pair of right and left pivot frames 104 that is provided continuously from the rear side of the main frames 103 to extend downward; and a pair of right and left seat rails 106 that extends rearward downward from the rear of the main frames 103.

On the body frame 101, an internal combustion engine 1 is installed, having its front and rear suspended by the engine hangers 105 and the pivot frames 104 below the main frames 103. A swingarm 113, having its front end pivotally held by the pivot frames 104, extends rearward. The swingarm 113 pivotally holds a rear wheel 114 by its rear end. An endless chain 117 is wrapped around a drive sprocket 115 fitted to an output shaft 9 of the internal combustion engine 1 and a driven sprocket 116 fitted to a rear axle.

Above the internal combustion engine 1, an air cleaner 12 is disposed to position behind the head pipe 102 in the body frame 101. A fuel tank 17 covering the rear and upper part of the air cleaner 12 is mounted on the main frames 103 in the body frame 101. Behind the fuel tank 17, a main seat 107 and a pillion seat 108 are supported by the seat rails 106.

In front of the internal combustion engine 1, a radiator 18 is disposed.

The internal combustion engine 1 forms a so-called power unit in which a transmission 8 is housed in a crankcase 2.

The internal combustion engine 1 is a water-cooled four-stroke inline-four engine that is laterally mounted on the body frame 101, having a crankshaft 7 oriented in the vehicle width direction (right-left direction) and the four cylinders aligned in the vehicle width direction.

The crankcase 2 is split into upper and lower pieces, namely, an upper crankcase 2a and a lower crankcase 2b, to pivotally hold from the upper and lower sides the crankshaft 7 that is oriented in the vehicle width direction (right-left direction).

A cylinder block 3, which is slightly inclined forward, integrally sits on the front upper part of the upper crankcase 2a. A cylinder head 4 is stacked on the cylinder block 3 and integrally fastened by stud bolts. A cylinder head cover 5 is put on the cylinder head 4. An oil pan 6 is attached to the bottom of the lower crankcase 2b. The crankcase 2 rotatably holds the crankshaft 7. The transmission 8 is housed behind the crankshaft 7.

The cylinder head 4 is slightly inclined forward, and has a rear lateral wall 4R where variable air funnels 21 are connected to the intake ports 4a of the four cylinders via throttle bodies 10, respectively.

The four variable air funnels 21 are disposed in parallel in the vehicle width direction in which the cylinders are arranged. The variable air funnel apparatus 20 includes the four variable air funnels 21 and their drive system. The four variable air funnels 21 are provided on the clean side of the air cleaner 12.

This forms intake passages that start from the intake ports 4a and pass through the throttle bodies 10 and the variable air funnels 21 to reach the air cleaner 12 (see FIG. 1).

At a front lateral wall 4F of the cylinder head 4, an exhaust pipe 15 connected to an exhaust port 4b extends forward. The exhaust pipe 15 then bends downward, extends rearward passing beneath the internal combustion engine 1, and further bends upward, to be connected to an exhaust muffler 16 disposed below the pillion seat 108 (see FIG. 1).

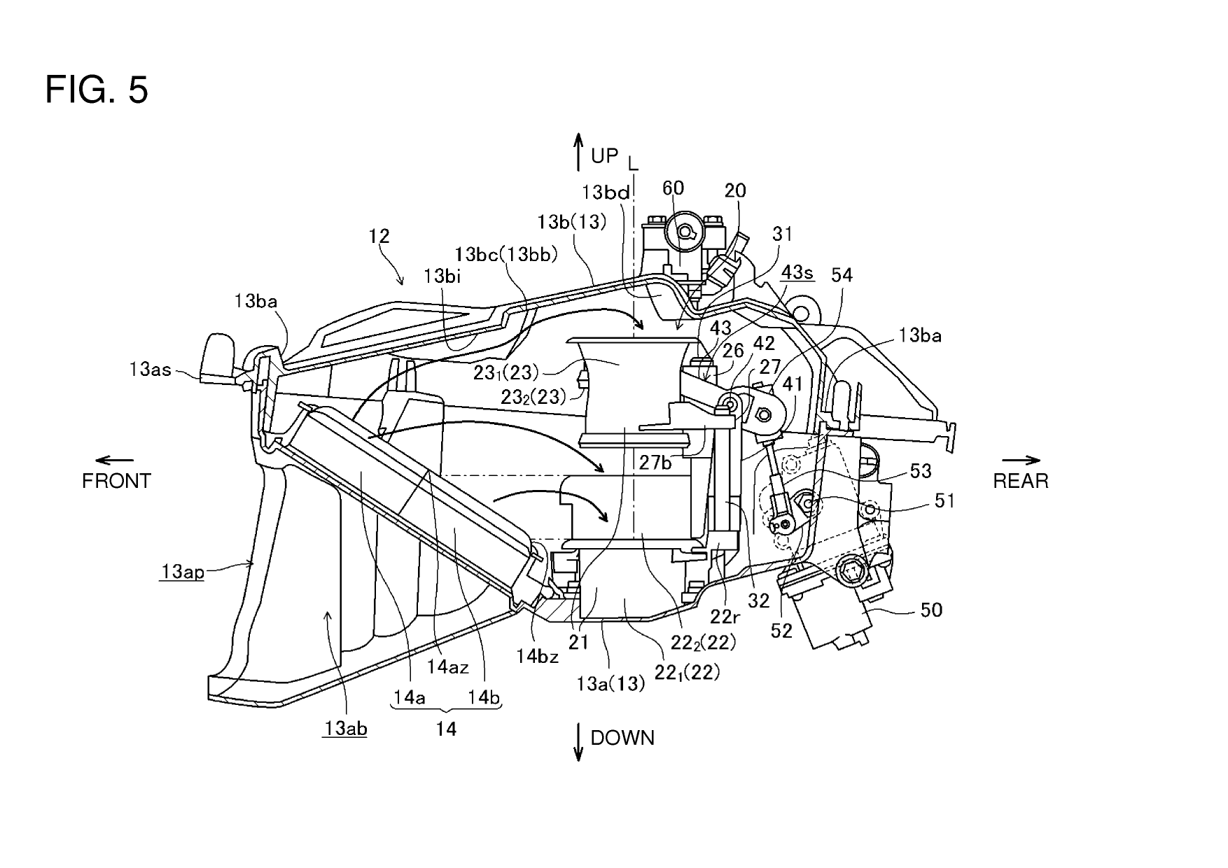

As shown in FIG. 5, the air cleaner 12 includes an air cleaner case 13, which is structured by a lower air cleaner case 13a and an upper air cleaner case 13b, and an air filter 14 disposed inside the air cleaner case 13.

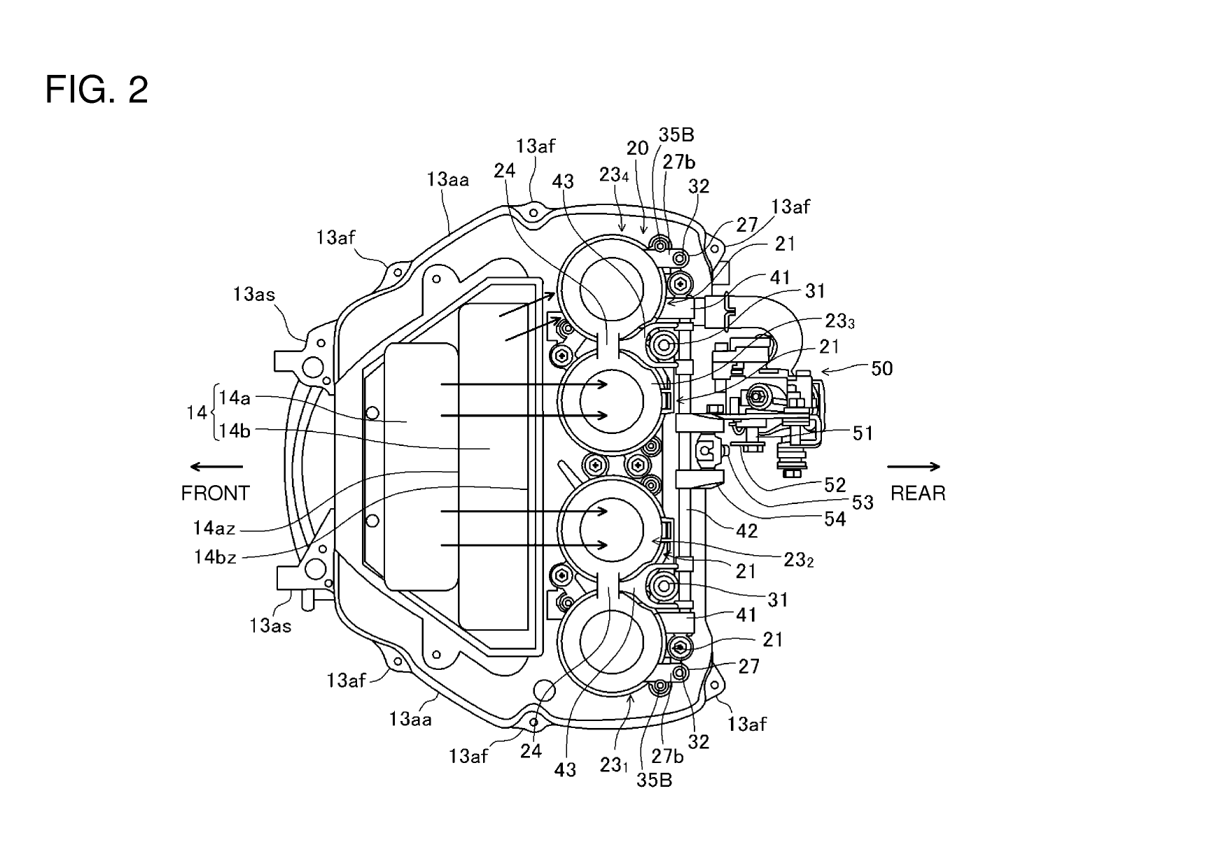

As shown in FIGS. 2 and 5, the air filter 14 is attached to the front of the air cleaner case 13 in the vehicle direction. On the rear side, four variable air funnels 21 of the variable air funnel apparatus 20 are disposed.

The variable air funnels 21 are provided to respectively correspond to the cylinders of the internal combustion engine 1.

The air filter 14 and the four variable air funnels 21 are disposed at the lower air cleaner case 13a.

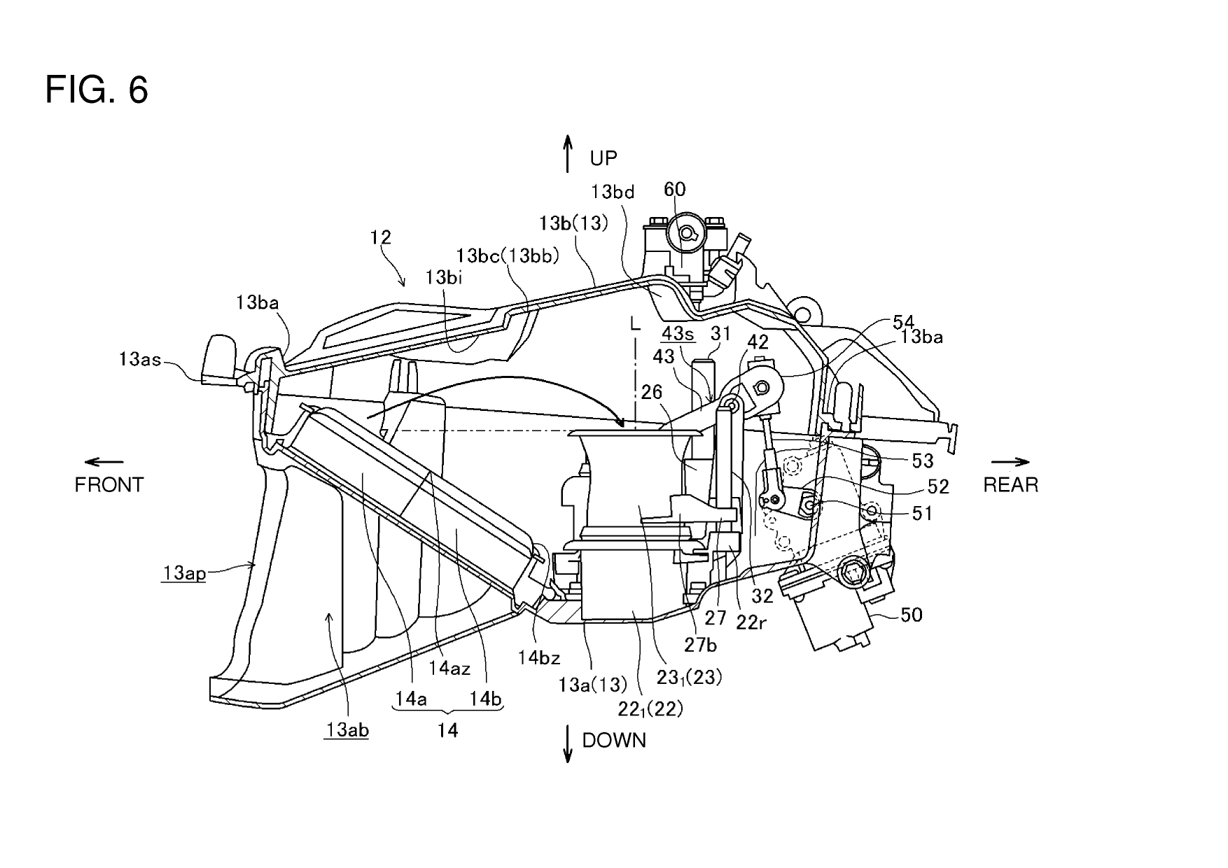

Referring to FIGS. 5 and 6, the lower air cleaner case 13a has its upper opening covered with the upper air cleaner case 13b.

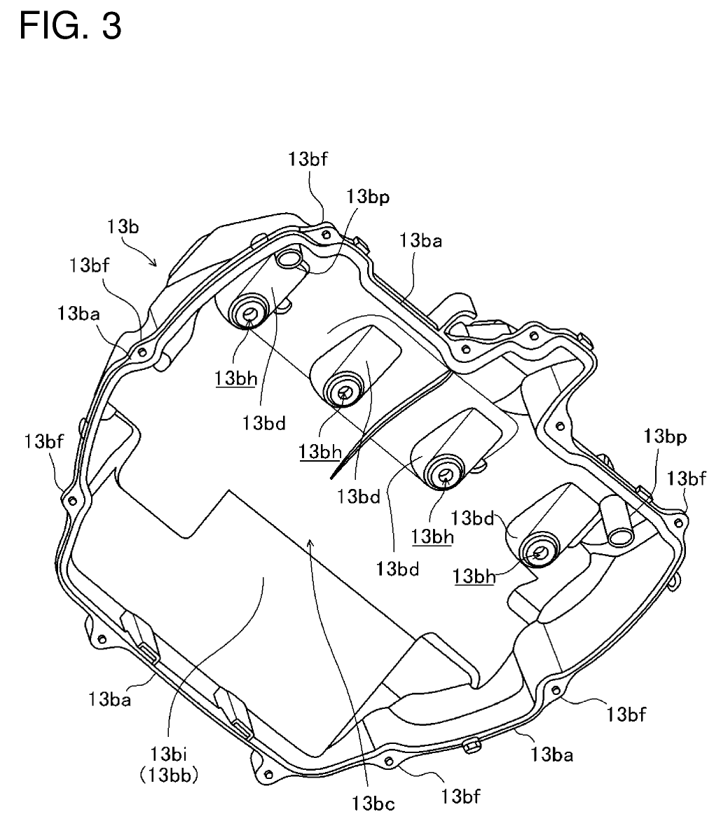

A plurality of fastening brackets 13af are provided to outwardly protrude at a periphery 13aa of the lower opening of the lower air cleaner case 13a (see FIG. 2). Fastening brackets 13bf are provided to outwardly protrude at a periphery 13ba of the upper opening of the upper air cleaner case 13b to correspond to the fastening brackets 13af (see FIG. 3).

By stacking the upper air cleaner case 13b on the lower air cleaner case 13a and fastening the fastening brackets 13af and the fastening brackets 13bf, which are in contact with each other, using bolts, the air cleaner case 13 is formed by the combined air cleaner cases.

A pair of right and left mount brackets 13as, 13as is provided to the lower air cleaner case 13a to protrude forward from the upper edge of the front wall (see FIGS. 2, 5, and 6).

The air cleaner case 13 is mounted on the body frame 101 by the mount brackets 13as.

In the lower air cleaner case 13a, the front bottom wall largely bulges downward to form an air supply chamber 13ab. An air supply port 13ap opens at the front of the air supply chamber 13ab.

The upper opening of the air supply chamber 13ab is closed by the air filter 14.

The air cleaner case 13, a combination of the lower air cleaner case 13a and the upper air cleaner case 13b, has its inside divided into the dirty side and the clean side by the air filter 14 provided in the lower air cleaner case 13a. The air supply chamber 13ab, which is lower than the air filter 14, corresponds to the dirty side. The space above and behind the air filter 14 corresponds to the clean side.

As shown in FIGS. 2 and 5, four variable air funnels 21 are mounted more rearward than the air filter 14 in the lower air cleaner case 13a.

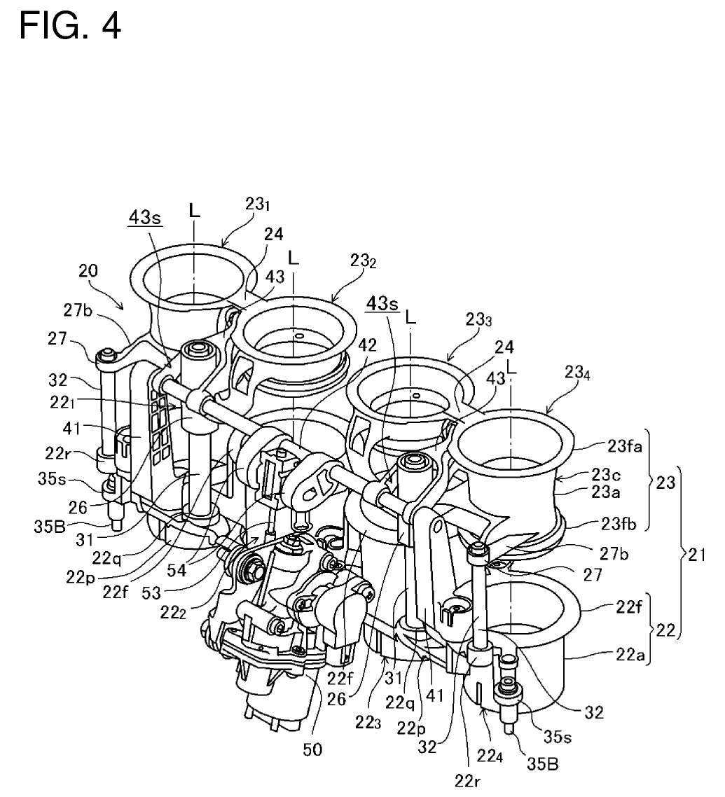

FIG. 4 is an overall perspective view of the variable air funnel apparatus 20, in which four variable air funnels 21 are arranged in parallel, and a drive system is disposed behind the variable air funnels 21.

Each variable air funnel 21 includes a fixed funnel 22 and a movable funnel 23 that shifts relative to the fixed funnel 22 in the central axis L direction of the fixed funnel 22.

The central axis L of the fixed funnel 22 is also the central axis of the movable funnel 23, or that of the variable air funnel 21.

As shown in FIGS. 4, 7, and 9, the four fixed funnels 22 are coupled by coupling parts 22p. Mount brackets 35s at the coupling parts 22p, and mount brackets 35s projecting at the outer fixed funnels 22 are mounted on the lower air cleaner case 13a by bolts 35B. Thus, the variable air funnel apparatus 20 is disposed at the lower air cleaner case 13a.

The fixed funnels 22 each include a cylindrical tube part 22a through which intake air passes. The upper end of the tube part 22a is folded back flange-like to be a flange part 22f.

On the other hand, the movable funnels 23 each include a tube part 23a through which intake air passes. The upper end of the tube part 23a is folded back flange-like to be an upstream-side flange part 23fa. Similarly, the lower end of the tube part 23a is formed as a downstream-side flange part 23fb.

The tube part 23a of each movable funnel 23 has, at its upper portion, a tapered part 23c of a reduced outer diameter.

Referring to FIGS. 4, 7, and 9, the four fixed funnels 22 arranged in parallel in the vehicle width direction are in the order of fixed funnels 22₁, 22₂, 22₃, 22₄from the left side. Above the fixed funnels 22₁, 22₂, 22₃, 22₄, the movable funnels 23₁, 23₂, 23₃, 23₄are correspondingly arranged, respectively.

The four fixed funnels 22₁, 22₂, 22₃, 22₄are arranged by being coupled by coupling parts 22p, having their bottoms aligned at an identical height. In the four fixed funnels 22₁, 22₂, 22₃, 22₄, the central fixed funnels 22₂, 22₃are higher than the outer fixed funnels 22₁, 22₄in height of their flange parts 22f with the upstream-end openings.

Accordingly, the central fixed funnels 22₂, 22₃are longer in channel length than the outer fixed funnels 22₁, 22₄.

Four movable funnels 23₁, 23₂, 23₃, 23₄shift together in the central axis L direction above the fixed funnels 22₁, 22₂, 22₃, 22₄, respectively.

The movable funnels 23₁, 23₂, 23₃, 23₄shift upward to reach a predetermined separated position where they are separated from the fixed funnels 22₁, 22₂, 22₃, 22₄, and shift downward to reach a coupled position where they are coupled to the fixed funnels 22₁, 22₂, 22₃, 22₄.

The four movable funnels 23₁, 23₂, 23₃, 23₄shift together by the same distance. At any shift position, all four have their upstream-side flange parts 23fa with the upstream-end openings aligned at an identical height.

The central movable funnels 23₂, 23₃are higher than the outer movable funnels 23₁, 23₄in height of their downstream-side flange parts 23fb with the downstream-end openings.

Accordingly, the central movable funnels 23₂, 23₃are shorter in channel length than the outer movable funnels 23₁, 23₄.

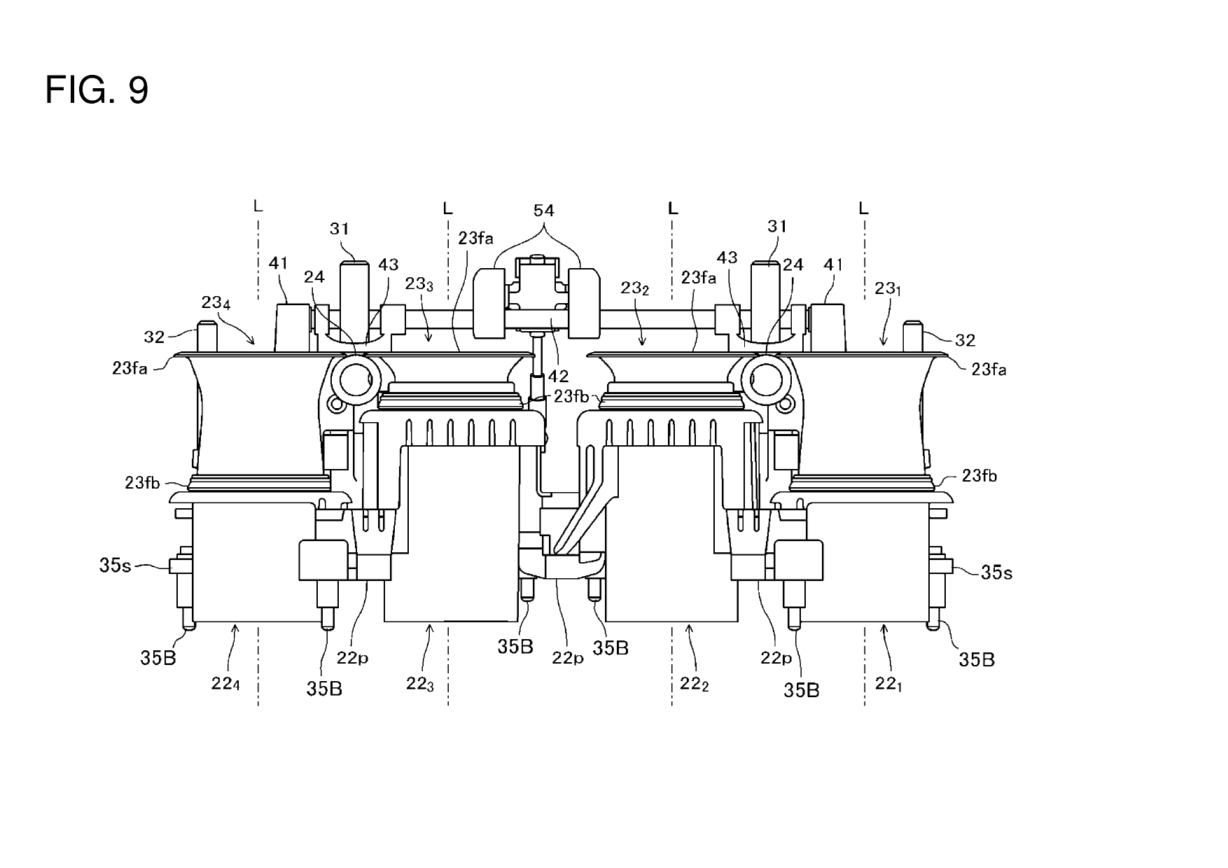

As shown in FIG. 9, when the movable funnels 23₁, 23₂, 23₃, 23₄ have shifted downward to be coupled to the fixed funnels 22₁, 22₂, 22₃, 22₄, the central movable funnels 23₁, 23₄longer in channel length are coupled to the central fixed funnels 22₁, 22₄shorter in path length; the outer movable funnels 23₂, 23₃shorter in channel length are coupled to the outer fixed funnels 23₂, 23₃ longer in channel length. All four movable funnels 23₁, 23₂, 23₃, 23₄ have their upstream-side flange parts 23fa with the upstream-end openings aligned at an identical height.

Accordingly, when the movable funnels 23₁, 23₂, 23₃, 23₄ are coupled to the fixed funnels 22₁, 22₂, 22₃, 22₄, the four variable funnels 21 become longer in effective funnel channel lengths, while being equal to each other among the four.

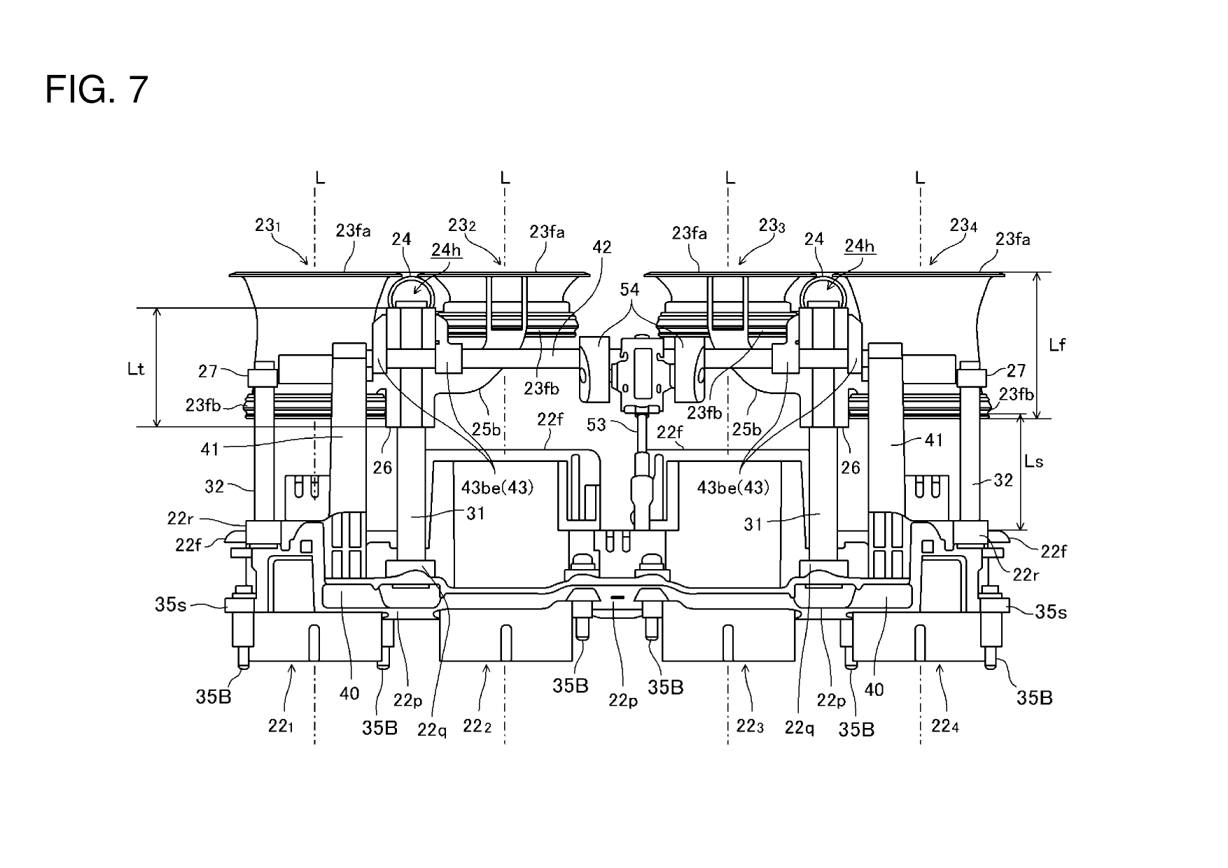

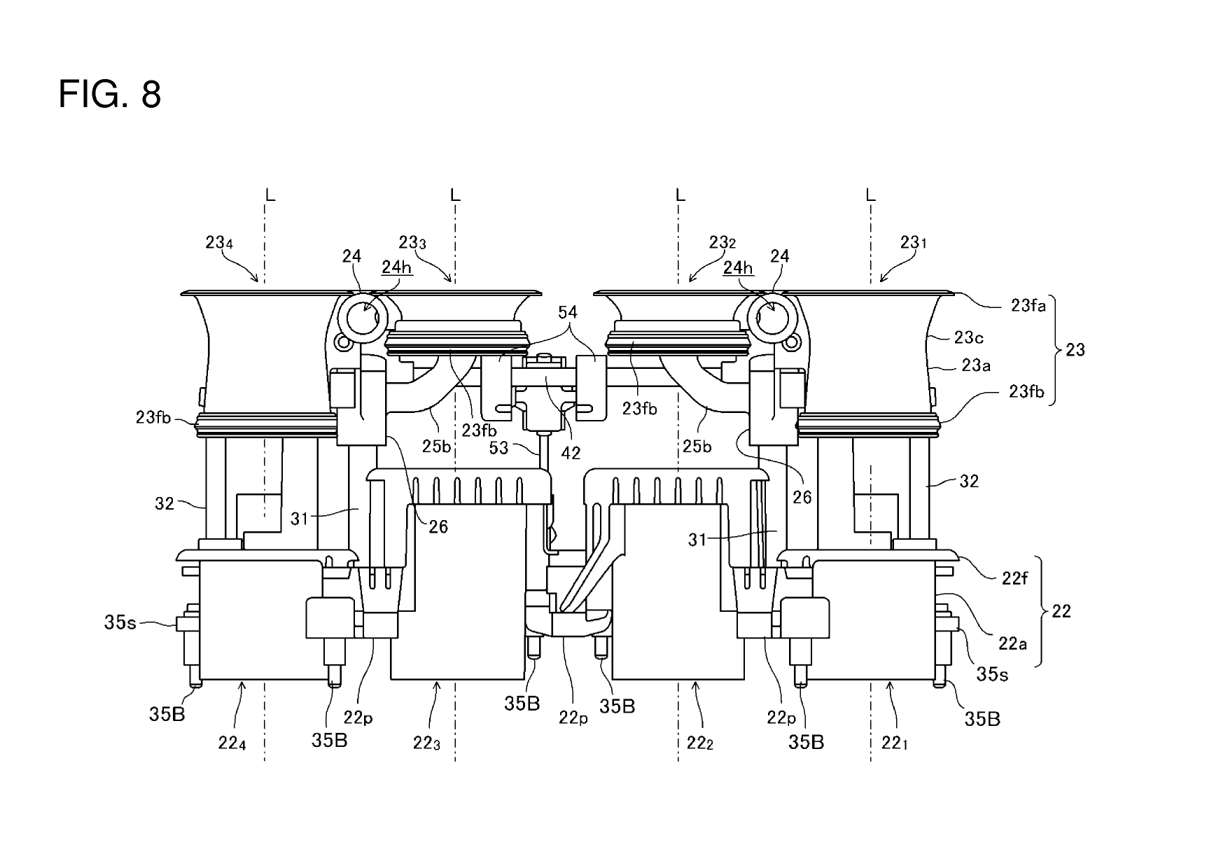

As shown in FIGS. 7 and 8, when the movable funnels 23₁, 23₂, 23₃, 23₄have shifted upward to be separated from the fixed funnels 22₁, 22₂, 22₃, 22₄, the effective funnel channel length as the four variable funnels 21 becomes that of the fixed funnels 22₁, 22₂, 22₃, 22₄, which is shorter than that when the movable funnels 23₁, 23₂, 23₃, 23₄ are coupled.

The outer fixed funnels 23₂, 23₃ are shorter than the central fixed funnels 22₁, 22₄ in channel length and also in effective funnel channel length.

In this manner, by the drive of an actuator 50, the variable air funnels 21 change the effective funnel channel length of the variable air funnels 21 working as the intake passage according to the engine speed of the internal combustion engine 1.

In a lower engine speed range, the variable air funnels 21 increase the effective funnel channel length; in a higher engine speed range, the variable air funnels 21 reduce the effective funnel channel length. Thus, the variable air funnels 21 adjust the intake air volume to optimize the output characteristics over the entire engine speed range.

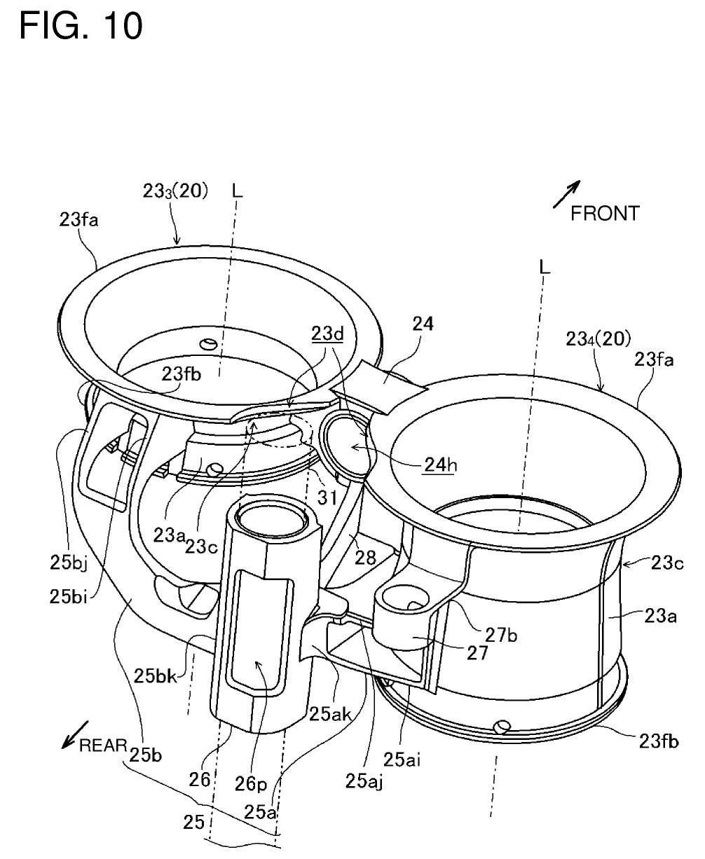

Referring to FIGS. 10 to 12, the outer-right movable funnel 23₄and the central movable funnel 23₃adjacent thereto are integrally coupled by a first coupling part 24 formed at a site where they become close to each other.

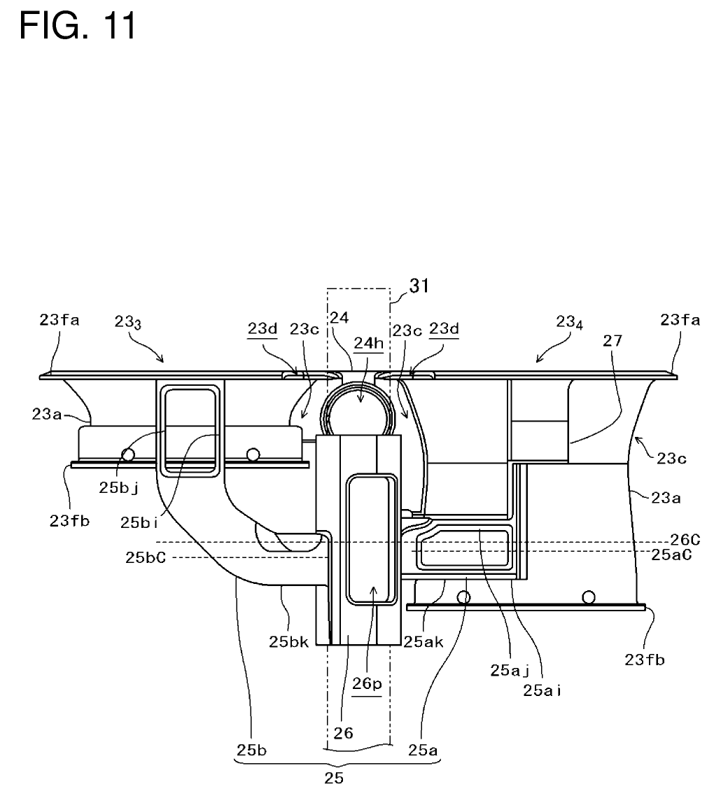

The first coupling part 24 is at the tapered parts 23c, 23c, which are the upper portions of the tube parts 23a, 23a below the upstream-side flange parts 23fa, 23fa of the movable funnels 23₃, 23₄ (see FIG. 11).

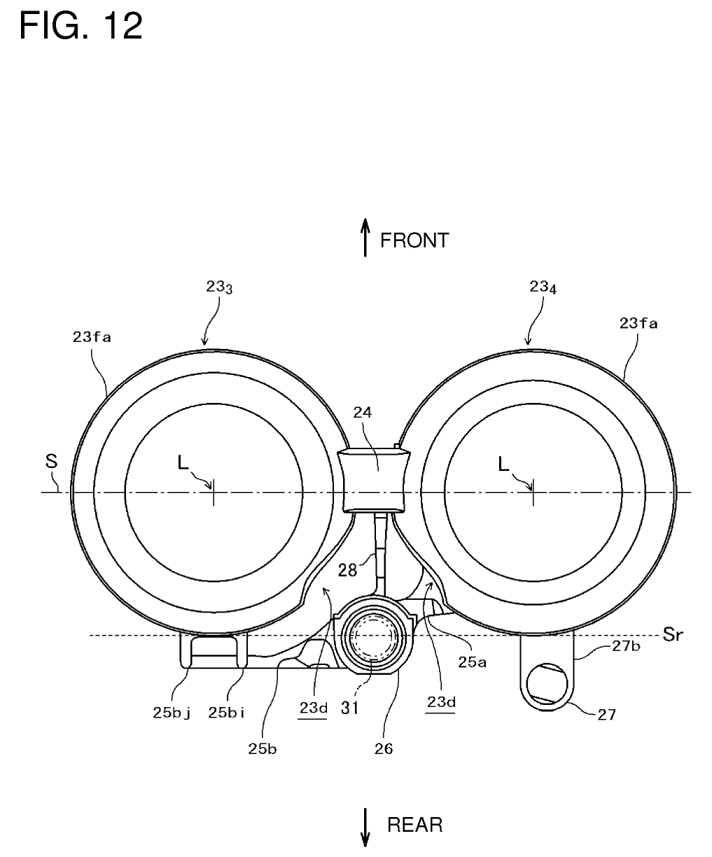

Furthermore, the first coupling part 24 is formed at a site slightly shifted forward from the central axis L of the movable funnels 23₃, 23₄ (see FIG. 12).

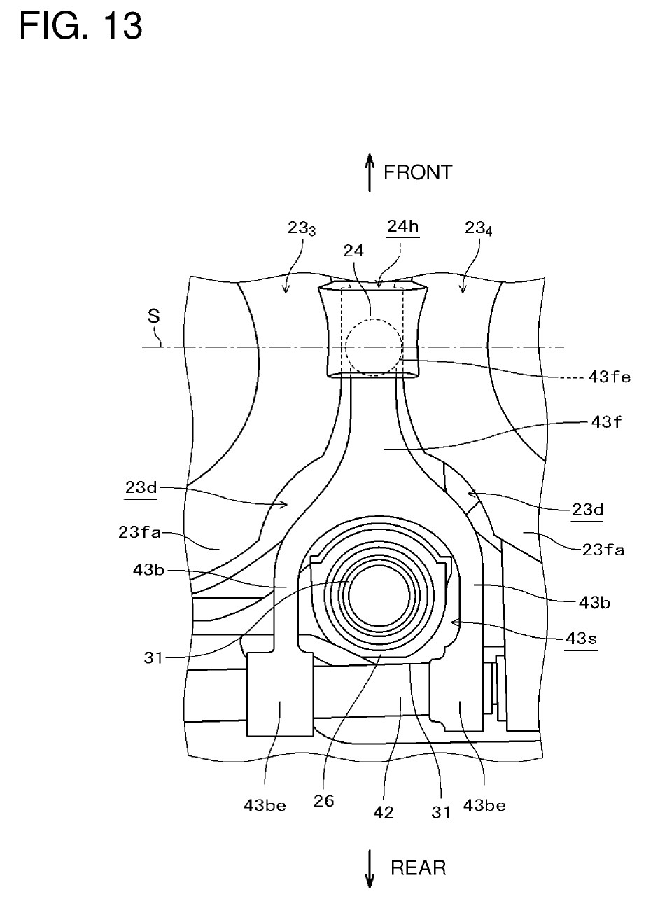

That is, referring to FIGS. 12 and 13, the first coupling part 24 is shifted toward the side opposite to a first guide shaft 31, which will be described later, relative to a plane S that includes two central axes L, L of the adjacent movable funnels 23₃, 23₄.

Note that an engaging round hole 24h bored in the front-rear direction is integrally formed at the first coupling part 24.

The outer-right movable funnel 23₄ and the central movable funnel 23₃ adjacent thereto are coupled to each other by a second coupling part 25 separately from the first coupling part 24.

The first coupling part 24 couples between at least the upper portions (tapered parts 23c, 23c) of the tube parts 23a, 23a of the movable funnels 23₃, 23₄adjacent to each other. The second coupling part 25 couples between the tube part 23a of the movable funnel 23₃and the lower portion of the tube part 23a of the movable funnel 23₄ (see FIG. 11).

The second coupling part 25 integrally includes a first engaging tube part 26 that slidably engages with the first guide shaft 31, which will be described later.

The first engaging tube part 26 has an elongated cylindrical shape whose central axis is parallel to the central axis L of the movable funnel 23. The second coupling part 25 includes a first coupling arm part 25a that extends from the first engaging tube part 26 to the outer-right movable funnel 23₄to be joined, and a second coupling arm part 25b that extends toward the adjacent movable funnel 23₃to be joined.

The first coupling arm part 25a joins sites 25ai, 25aj that are separated from each other in the top-bottom direction at a lower part of the tube part 23a of the movable funnel 23₄. The second coupling arm part 25b joins two sites 25bi, 25bj, that are separated from each other in the circumferential direction of the tube part 23a of the movable funnel 23₃. Note that a coupling part 28 couples between the portion around the front central part of the first engaging tube part 26 and the lower part of the first coupling part 24.

Referring to FIG. 11, a central position 25aC in the top-bottom direction of the upper and lower sides of an extending site 25ak extending from the engaging tube part 26 of the first coupling arm part 25a and a central position 25bC in the top-bottom direction of the upper and lower sides of an extending site 25bk extending from the engaging tube part 26 of the second coupling arm part 25b are positioned lower than a central position 26C in the top-bottom direction of the engaging tube part 26.

Referring to a rear view of FIG. 11, the first engaging tube part 26 overlaps with the first coupling part 24 as seen in a front view.

As shown in FIG. 12, the first engaging tube part 26 is at least partially set between the adjacent movable funnels 23₃, 23₄.

That is, the first engaging tube part 26 is partially set forward than a tangent Sr that is in contact with the outer circumference of both of the adjacent movable funnels 23₃, 23₄ on the rear side.

Thus, the outer-right movable funnel 23₄ and the adjacent central movable funnel 23₃ are integrally coupled by the first coupling part 24 and the second coupling part 25.

The first engaging tube part 26 has an opening 26p elongated in the top-bottom direction at the surface being slidably in contact with the first guide shaft 31, which will be described later (see FIG. 10).

The outer-right movable funnel 23₄has a bracket 27b protruding rearward from the tube part 23a. At the edge of the bracket 27b, a second engaging tube part 27 that slidably engages with a second guide shaft 32, which will be described later, is formed.

The outer-left movable funnel 23₁and the adjacent central movable funnel 23₂have vertical symmetry with the outer-right movable funnel 23₄and the adjacent central movable funnel 23₃, and are integrally coupled by the first coupling part 24 and the second coupling part 25, which similarly have vertical symmetry.

The variable air funnels 21 configured by the movable funnels 23 and the fixed funnels 22 on the top and bottom sides are arranged in four pieces in parallel in the right-left direction. Referring to FIG. 4, the first guide shaft 31 stands upright by being retained by a retaining bracket 22q provided at the coupling part 22p between the fixed funnels 22₁, 22₂ to oppose, from the rear side, the first coupling part 24 that couples between the outer-left movable funnel 23₁and the adjacent central movable funnel 23₂.

Similarly, the first guide shaft 31 stands upright by being retained by a retaining bracket 22q provided at the coupling part 22p between the fixed funnels 22₃, 22₄ to oppose, from the rear side, the first coupling part 24 that couples between the outer-right movable funnel 23₄and the adjacent central movable funnel 23₃.

The left first guide shaft 31 stands upright between the movable funnels 23₁, 23₂. The right first guide shaft 31 stands upright between the movable funnels 23₃, 23₄.

The right and left first engaging tube parts 26, 26 slidably engage with the right and left first guide shafts 31, 31, respectively.

The second guide shaft 32 stands upright by being retained by a retaining bracket 22r that projects rearward from the left rear part of the tube part 22a of the outer-left fixed funnel 22₁.

Similarly, the second guide shaft 32 stands upright by being retained by a retaining bracket 22r that projects rearward from the right rear part of the tube part 22a of the outer-right fixed funnel 22₄.

The left second guide shaft 32 is retained at the inner position than the left outermost part of the outer-left fixed funnel 22₁. The right second guide shaft 32 is retained at the inner position than the right outermost part of the outer-right fixed funnel 22₄.

The second engaging tube parts 27, 27 of the right and left outer movable funnels 23₁, 23₄ slidably engage with the right and left second guide shafts 32, 32, respectively.

Accordingly, by being integrally coupled by the first coupling part 24 and the second coupling part 25, the outer-left movable funnel 23₁and the adjacent central movable funnel 23₂vertically shift in parallel between the upper separated position and the lower coupled position while being guided by the left first guide shaft 31 and the second guide shaft 32.

Similarly, by being integrally coupled by the first coupling part 24 and the second coupling part 25, the outer-right movable funnel 23₄and the adjacent central movable funnel 23₃vertically shift in parallel between the upper separated position and the lower coupled position while being guided by the right first guide shaft 31 and the second guide shaft 32.

A supporting bracket 40 protrudes rearward from the right rear part of the lower side of the tube part 22a of the outer-left fixed funnel 22₁. A pillar 41 stands upright, having its lower end supported by the supporting bracket 40.

Similarly, a supporting bracket 40 protrudes rearward from the left rear part of the lower side of the tube part 22a of the outer-right fixed funnel 22₄. A pillar 41 stands upright, having its lower end supported by the supporting bracket 40.

Referring to FIG. 7, a pair of right and left pillars 41, 41 stands upright to have vertical symmetry. A rotary shaft 42 is rotatably and horizontally suspended between the upper ends of the pair of pillars 41, 41.

In the rear view of FIG. 7, the pair of right and left pillars 41, 41 is disposed outer than the right and left first guide shafts 31, 31 in the right-left direction. The rotary shaft 42 suspended between the pair of pillars 41, 41 is at a higher position than the fixed funnels 22₂, 22₃, behind and closer to the right and left first guide shafts 31, 31.

The pair of right and left pillars 41, 41 is disposed inner than the right and left second guide shafts 32, 32 in the right-left direction (see FIG. 7).

To the rotary shaft 42, arm members 43 are attached at two locations inner than the pair of pillars 41, 41, respectively.

Referring to FIG. 13, each arm member 43 is Y-shaped, with two branch parts 43b, 43b split from a trunk part 43f. The branch parts 43b, 43b have their ends as basal ends 43be, 43be fixed to the rotary shaft 42. From the basal ends 43be, 43be, the branch parts 43b, 43b and the trunk part 43f extend forward. A spherical end 43fe spherically bulged at the tip of the trunk part 43f loosely fits into the engaging round hole 24h of the first coupling part 24.

The first guide shaft 31, opposed to the first coupling part 24, is positioned between the first coupling part 24 and the rotary shaft 42. Accordingly, the arm member 43 has a hollow part 43s between the split branch parts 43b, 43b to avoid interference with the first guide shaft 31. The first guide shaft 31 penetrates through the hollow part 43s of the arm member 43 (see FIG. 13).

Similarly, the first engaging tube part 26 that slidably engages with the first guide shaft 31 can penetrate through the hollow part 43s of the arm member 43.

The arm member 43 has its basal ends 43be, 43be fitted to the rotary shaft 42. When the rotary shaft 42 rotates, since the spherical end 43fe at the tip of the trunk part 43f extending forward vertically swings, force acts on the first coupling part 24 that forms the engaging round hole 24h where the spherical end 43fe engages by loosely fitting, the first coupling part 24 vertically shifts integrally with the adjacent movable funnels 23₁, 23₂ (23₃, 23₄).

The upstream-side flange parts 23fa, 23fa of the movable funnels 23₁, 23₂ (23₃, 23₄) are provided with recesses 23d, 23d to avoid interference with the swinging branch parts 43b, 43b of the arm member 43 (see FIG. 13).

As shown in FIGS. 2, 4, and 5, the drive system that rotates the rotary shaft 42 is behind the rotary shaft 42. The actuator 50 mounted on the outer surface of the rear wall of the lower air cleaner case 13a is positioned more rightward than the center.

The output shaft 51 of the actuator 50 penetrates the rear wall of the lower air cleaner case 13a leftward. One end of a first link member 52 is fitted to the left end of the output shaft 51 so as not to rotate relative to it inside the lower air cleaner case 13a.

One end of the second link member 53 is rotatably coupled to the other end of the first link member 52. One end of a third link member 54 is rotatably coupled to the other end of the second link member 53.

The other end of the third link member 54 is attached to the rotary shaft 42 so as not to rotate relative to it.

The rotary force of the output shaft 51 of the actuator 50 is transferred to the rotary shaft 42 via the first link member 52, the second link member 53, and the third link member 54 rotatably coupled to each other.

FIG. 5 shows a state where the movable funnels 23 are in the separated position where they are separated from the fixed funnels 22. The drive of the actuator 50 causes the first link member 52 to swing downward, which pulls the second link member 53 downward and swings the third link member 54 downward. Thus, the rotary shaft 42 rotates and causes the arm member 43 to swing upward, and causes the first coupling part 24 engaging with the spherical end 43fe at the tip of the arm member 43 to shift upward integrally with the coupled adjacent movable funnels 23₁, 23₂(23₃, 23₄).

Here, the first engaging tube part 26 of the second coupling part 25 that couples the adjacent movable funnels 23₁, 23₂ (23₃, 23₄) together with the first coupling part 24 has shifted upward as being guided by the first guide shaft 31 and set in the hollow part 43s, penetrating through the hollow part 43s between the branch parts 43b, 43b of the arm member 43 (see FIGS. 5 and 7).

FIG. 6 shows a state where the movable funnels 23 are in the coupled position, being coupled to the fixed funnels 22. The drive of the actuator 50 rotates the rotary shaft 42 through the first link member 52, the second link member 53, and the third link member 54, swinging the arm member 43 downward and shifting the first coupling part 24 downward integrally with the adjacent movable funnels 23₁, 23₂ (23₃, 23₄).

Here, the first engaging tube part 26 of the second coupling part 25 has shifted downward as being guided by the first guide shaft 31, passing downward through the hollow part 43s between the branch parts 43b, 43b of the arm member 43 (see FIG. 6).

Referring to FIG. 7, with the cylindrical first engaging tube part 26, the contact length by which the first engaging tube part 26 slidably contacts with the first guide shaft 31 corresponds to its tube length Lt. The tube length Lt of the first engaging tube part 26 is set to be longer than the stroke length Ls of the movable funnel 23 reciprocating between the coupled position and the separated position.

This allows the first engaging tube part 26 that is engaging with the first guide shaft 31 to smoothly slide without being stuck.

The tube length Lt of the first engaging tube part 26A is shorter than a funnel length Lf of the movable funnel 23₁ (23₄), which is longer in funnel length among the coupled movable funnels. This achieves a compact layout with the properly reduced first engaging tube part 26.

As shown in FIGS. 2 and 5, on the front side of the lower air cleaner case 13a, the air filter 14 is disposed. On the rear side, the variable air funnels 21 are arranged in four pieces in the right-left vehicle width direction.

As shown in FIG. 5, the air filter 14 is tilted, having its upper surface oriented toward the variable air funnels 21 on the rear side, or oriented diagonally rearward upward.

The air filter 14 consists of two upper and lower units, namely, an upper air filter 14a and a lower air filter 14b.

Since the air filter 14 is tilted, the upper air filter 14a and the lower air filter 14b are positioned on the front and rear sides, respectively, and the upper air filter 14a is at a higher position than the lower air filter 14b (see FIG. 5).

The lower air filter 14b is larger in right-left width than the upper air filter 14a (see FIG. 2).

In the top view of FIG. 2, the upper air filter 14a at a higher position and smaller in right-left width corresponds to, in the front-rear direction, the central two movable funnels 23₂, 23₃out of the four movable funnels 23₁, 23₂, 23₃, 23₄ arranged in the right-left direction. The lower air filter 14b at a lower position and larger in right-left width substantially corresponds to, in the front-rear direction, four movable funnels 23₁, 23₂, 23₃, 23₄ (and fixed funnels 22₁, 22₂, 22₃, 22₄).

As shown in FIGS. 2 and 5, a lower side 14az of the upper air filter 14a of the lower side air filter 14 is substantially at the same height as the upstream-end openings of the fixed funnels 22₂, 22₃, whose upstream-end openings are at a higher position.

In other words, the upper side of the lower air filter 14b is at a slightly lower position than the upstream-end openings of the fixed funnels 22₂, 22₃.

Furthermore, a lower side 14bz of the lower air filter 14b is substantially at the same height as the upstream-end openings of the fixed funnel 22₁, 22₄, whose upstream-end openings are at a lower position.

Accordingly, as shown in FIG. 5, when the movable funnels 23 are in the separated position where they are separated from the fixed funnels 22, the air having passed through the upper air filter 14a at a substantially higher position tends to be taken into the upstream-end openings of the upstream-side flange parts 23f of the fixed funnels 22₂, 22₃ at a higher position; and the air passed through the lower air filter 14b at a substantially lower position tends to be taken into the upstream-end openings of the upstream-side flange parts 23f of the outer fixed funnels 22₁, 22₄ at a lower position. In particular, out of the four fixed funnels 22₁, 22₂, 22₃, 22₄ arranged in the vehicle width direction, the outer fixed funnels 22₁, 22₄ correspond to, in the front-rear direction, the lower air filter 14b being larger in right-left width, and the air having passed through the right and left sides of the lower air filter 14b is taken into the upstream-end openings of the outer fixed funnels 22₁, 22₄ at a lower position (see FIGS. 2 and 5).

That is, when the movable funnels 23 are in the separated position, air from different height layers in the air cleaner case 13 is efficiently taken into the fixed funnels 22 having the upstream-end openings of different heights. This further improves intake efficiency. A higher output is expected with a higher engine speed range where the movable funnels 23 are in the separated position.

As shown in FIG. 6, when the movable funnels 23 are in the coupled position where they are coupled with the fixed funnels 22, the upper air filter 14a is at the same height position as the upstream-end openings of the upstream-side flange parts 23fa of the movable funnels 23 in the coupled position. The air having passed through substantially the upper air filter 14a is taken into the upstream-end openings of the movable funnels 23 in the coupled position.

Referring to FIGS. 5 and 6, fuel injection valves 60 are mounted on the upper air cleaner case 13b while being spaced apart on further upstream side from the four movable funnels 23₁, 23₂, 23₃, 23₄ arranged in the vehicle width direction, to inject fuel toward the upstream-side openings of the movable funnels 23, respectively (see FIGS. 5 and 6).

In the upper air cleaner case 13b, an upper wall 13bb bulges upward from a periphery 13ba that is in contact with the lower air cleaner case 13a. The upper wall 13bb is formed to have an inclined wall 13bc that gradually increases its height rearwardly from the front edge of the periphery 13ba. The rear of the inclined wall 13bc is curved downward to reach the rear edge.

As shown in FIG. 3, at four places in the upper wall 13bb on the front side where the inclined wall 13bc becomes highest, projections 13bd projecting inward are formed by being inwardly recessed as shown in FIG. 3 to oppose the upstream-side openings of the movable funnels 23₁, 23₂, 23₃, 23₄. A round hole 13bh is bored at each projection 13bd.

A fuel injection valve 60 is mounted on the outer recess formed by each projection 13bd. The fuel injection valve 60 injects fuel from the round hole 13bh toward the upstream-side opening of the movable funnel 23.

As shown in FIG. 5, the upper air cleaner case 13b has an air guiding shape in which: the inclined wall 13bc and the projections 13 bd of the upper wall 13bb guide the air having passed through the upper air filter 14a of the air filter 14a and flowing upward rearward along a ceiling surface 13bi, which is the inner surface of the inclined wall 13bc of the upper wall 13bb; once the air arrives at the projection 13bd, the air is guided downward along the front walls of the projections 13bd to the movable funnels 23 positioned beneath the front walls of the projections 13bd, particularly the upstream-end openings of the movable funnels 23 in the separated position.

Accordingly, as shown in FIG. 5, the air guided by the air guiding shape of the ceiling surface 13bi of the upper air cleaner case 13b flows into the upstream-end openings of the movable funnels 23 in the separated position. The air having passed through the movable funnels 23 joins the intake airflow taken in from the upstream-end openings of the fixed funnels 22. This further improves intake efficiency with the separated movable funnels.

The air guided by the air guiding shape formed at the ceiling surface 13bi by the inclined wall 13bc and the projections 13bd of the upper wall 13bb of the upper air cleaner case 13b flows toward the upstream-end openings of the movable funnels 23. This airflow efficiently introduces the fuel injected by the fuel injection valves 60 at the recesses formed by the projections 13bd into the variable air funnels 21.

While not shown in the drawings, the throttle bodies 10 are provided with fuel injection valves. The fuel injected by these fuel injection valves and the fuel injected by the fuel injection valves 60 are mixed with the intake air, and the resultant air-fuel mixture is sent to the combustion chamber of the internal combustion engine 1 to be combusted.

As shown in FIG. 3, at the ceiling surface 13bi of the upper wall 13bb of the upper air cleaner case 13b, cylindrically-shaped cylindrical retaining parts 13bp, 13bp project downward at the locations corresponding to the two right and left second guide shafts 32, 32 that guide shifting of the movable funnels 23 of the variable air funnel apparatus 20.

When the upper air cleaner case 13b is put on the lower air cleaner case 13a, the upper ends of the two second guide shafts 32, 32 that stand upright in the lower air cleaner case 13a are inserted into and retained by the cylindrical retaining parts 13bp, 13bp of the upper air cleaner case 13b.

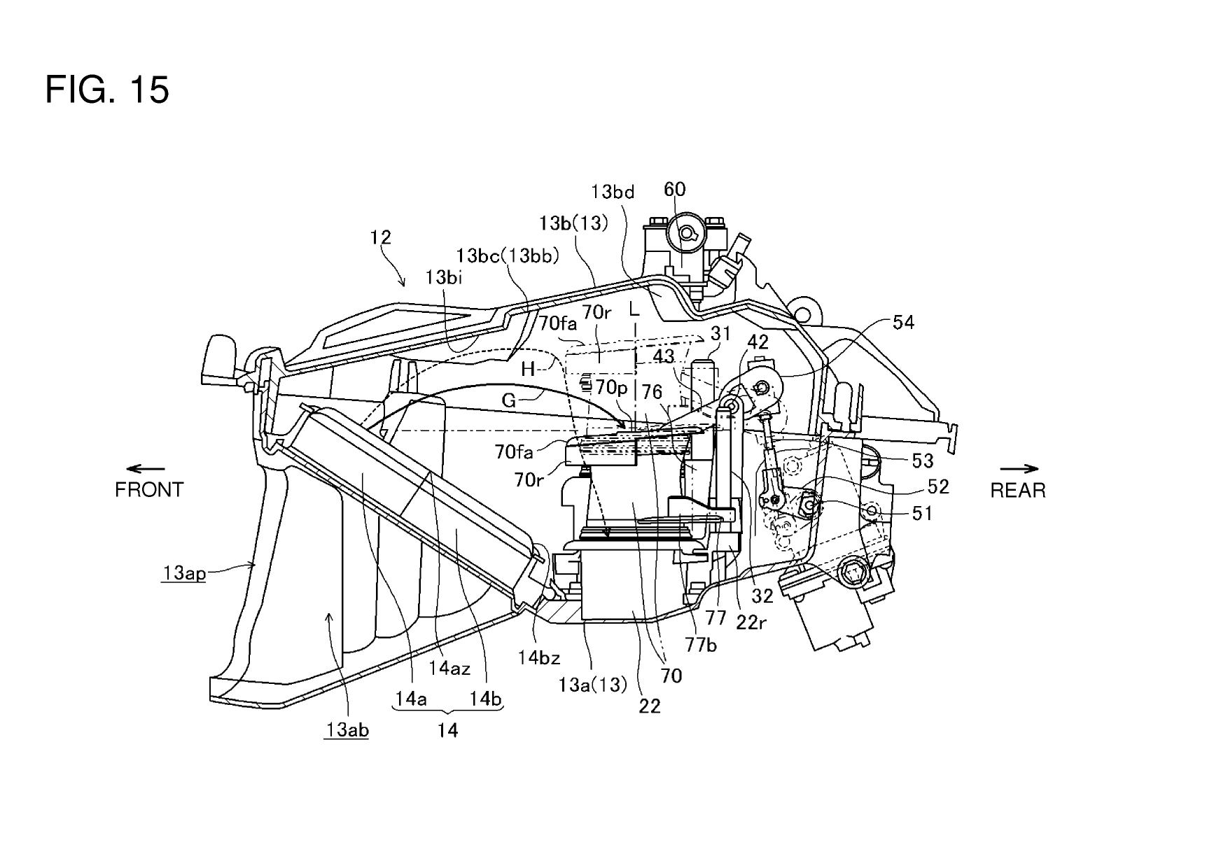

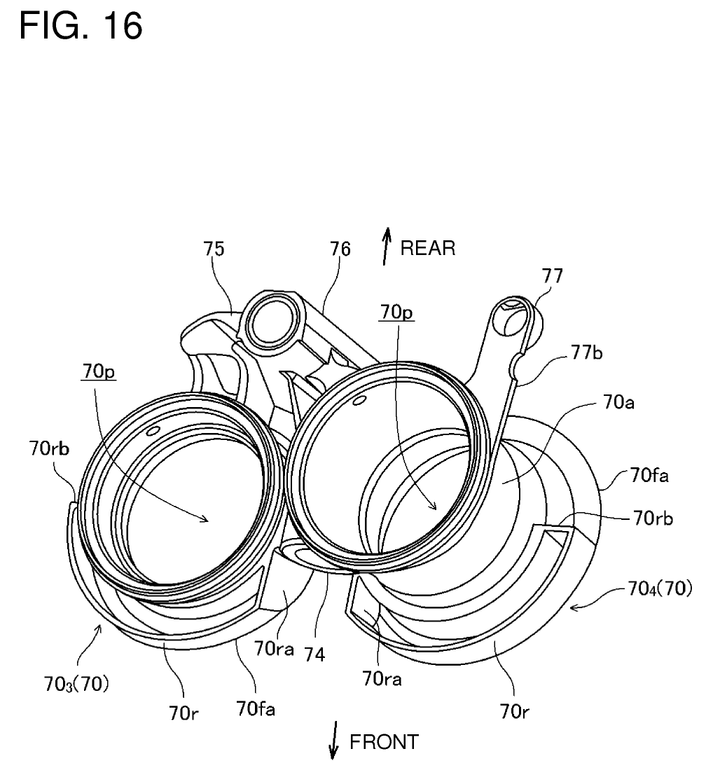

Next, referring to FIGS. 15 and 16, a variation of the movable funnels will be described.

Movable funnels 70 are shaped substantially the same as the movable funnels 23, except that an upstream-end opening plane 70p of an upstream-side flange part 70fa of a tube part 70a is inclined toward the air filter 14, and a rib 70r is formed at the upstream-side flange part 70fa.

Since the movable funnels 70 are identical to those described above except for the upstream-side flange part 70fa, the same sites or members will be denoted by the same reference characters.

As shown in FIG. 15, four movable funnels 70 arranged in parallel in the vehicle width direction behind the air filter 14 have their upstream-end opening planes 70p inclined toward the air filter 14. That is, the upstream-end opening plane 70p is oriented upward and forward while being slightly angled.

Since the upper surface of the upstream-side flange part 70fa has its rear side set higher than the front side, the upstream-end opening plane 70p is inclined.

As indicated by a solid arrow G in FIG. 15, when the movable funnels 70 are in the coupled position relative to the fixed funnels 22, the air having passed through the air filter 14 is easily taken into the upstream-side openings of the movable funnels 70 as they are inclined toward the air filter 14. This improves intake efficiency.

FIG. 16 shows a structure in which an outer-right movable funnel 70₄and its adjacent central movable funnel 70₃are integrally coupled by a first coupling part 74 and a second coupling part 75.

This structure is the same as the one described, referring to FIG. 10.

Accordingly, the second coupling part 75 integrally has an engaging tube part 76. In the outer-right movable funnel 70₄, a bracket 77b projects rearward from the tube part 70a. A second engaging tube part 77 is formed at the end of the bracket 77b to slidably engage with the second guide shaft.

As shown in FIG. 16, the ribs 70r hanging down toward the downstream side from the periphery of the upstream-side flange parts 70fa of the movable funnels 70 are at the periphery opposite to the periphery of the upstream-side flange parts 70fa of the movable funnels 70₃, 70₄ coupled by the second coupling part 75.

This similarly applies to the left adjacent movable funnels 70.

One side (rear) of the adjacent movable funnels 70 is coupled to each other by the second coupling part 75, and the other side (front) is provided with the ribs 70r at the periphery of the upstream-side flange parts 70fa of the movable funnels 70. This improves the rigidity of the adjacent movable funnels 70 and suppresses distortion or deflection.

Referring to FIG. 16, the ribs 70r have their ends 70ra, 70rb, on the side where the adjacent movable funnel 70₃and movable funnel 70₄juxtapose to each other, extended rearward to be connected to the front-end side of the first coupling part 74.

The ribs 70r have their ends 70rb, 70rb opposite to the ends 70ra, 70ra extended toward the tube part 70a to be connected to the tube part 70a.

Since the ribs 70r each form a sector-shaped frame that encloses four sides in cooperation with the tube part 70a and both ends 70ra, 70rb, the ribs 70r exhibit high rigidity.

The ribs 70r extending toward the downstream side from the periphery of the upstream-side flange parts 70fa of the movable funnels 70 are oriented toward the fixed funnels 22. Therefore, when the movable funnels 70 are in the separated position (indicated by the imaginary line in FIG. 15), the air having passed through the air filter 14, which is indicated by a broken arrow H representing the airflow in FIG. 15, hits the ribs 70r and is urged to flow downward, to be easily taken into the upstream-side openings of the fixed funnels 22. This contributes to improving intake efficiency.

The variable air funnel apparatus according to one embodiment of the present invention described in detail above achieves the following effects.

As shown in FIG. 5, when the movable funnels 23 are in the separated position where they are separated from the fixed funnels 22, at least one of the fixed funnels 22 is different from the other fixed funnels 22 in height of their upstream-end openings, and at least one of the effective funnel channel lengths is different from the other effective funnel channel lengths. Accordingly, when the movable funnels 23 are in the separated position, there are fixed funnels 22₂, 22₃ having their upstream-end openings taking in air positioned higher and fixed funnels 22₁, 22₄ having their upstream-end openings positioned lower. These fixed funnels 22, differing in the height of upstream-end openings, efficiently take in air from different height layers in the air cleaner case 13. This further improves intake efficiency. A higher output is expected with a higher engine speed range where the movable funnels 23 are in the separated position.

When the movable funnels 23 are in the separated position, out of the fixed funnels 22₁, 22₂, 22₃, 22₄ arranged in parallel, the central fixed funnels 22₂, 22₃ are higher than the outer fixed funnels 22₁, 22₄in height of their upstream-end openings, and therefore are longer in effective funnel channel length. Thus, the movable funnels of different intake passage lengths provide varied output characteristics and reduce vibrations and acoustic resonance.

As shown in FIG. 4, the first coupling part 24 (24) is at the site where the adjacent movable funnels 23₁, 23₂ (23₃, 23₄) become close to each other. The drive of the actuator 43 (43) acts on the first coupling part 24 (24), whereby the adjacent movable funnels 23₁, 23₂ (23₃, 23₄) integrally shift. Thus, the drive of the actuator 43 (43) acts on the first coupling part 24 (24) positioned at substantially the center of the adjacent movable funnels 23₁, 23₂ (23₃, 23₄). The integrally coupled movable funnels 23₁, 23₂ (23₃, 23₄) are less prone to having deformations such as distortion, deflection, or twist. The movable funnels can integrally shift smoothly without friction. The movable funnels 23₁, 23₂ (23₃, 23₄) can closely sit on their respective fixed funnels 22₁, 22₂ (22₃, 22₄).

When three or more movable funnels are coupled, they become elongated as a whole in the parallel direction, increasing the risk of distortion or twist when shifting. For a plurality of movable funnels to closely sit together on fixed funnels, tolerances must be kept small, and therefore, mass production is difficult. On the other hand, the movable funnels 23₁, 23₂ (23₃, 23₄) of just two pieces coupled to each other can closely sit together on the fixed funnels 22₁, 22₂ (22₃, 22₄) with improved accuracy, even if the tolerances are standard.

As shown in FIG. 11, the first coupling part 24 is provided at the tapered parts 23c of the movable funnels 23. Since the first coupling part 24 is accommodated in the space formed by the tapered parts 23c, 23c of the adjacent movable funnels 23₁, 23₂ (23₃, 23₄), the adjacent movable funnels 23₁, 23₂ (23₃, 23₄) can be coupled close to each other. This contributes to reducing the size of the variable air funnel apparatus.

As shown in FIGS. 4 and 7, the fixed funnels 22 retain the first guide shafts 31 (31) oriented in their central axis direction to oppose the first coupling parts 24 (24) of the adjacent movable funnels 23₁, 23₂ (23₃, 23₄). The movable funnels 23₁, 23₂ (23₃, 23₄) slidably engage with and are guided by the first guide shafts 31 (31) in shifting. Accordingly, the drive of the actuator is effectively transferred to the shifting of the movable funnels 23₁, 23₂(23₃, 23₄) via the first coupling part 24 (24) to shift the movable funnels 23₁, 23₂(23₃, 23₄) smoothly.

As shown in FIGS. 4 and 7, since the present embodiment includes, separately from the first guide shaft 31, the second guide shafts 32 (32) that slidably engage with and guide the outermost movable funnels 23₁(23₄), the movable funnels 23₁(23₄) are shifted more smoothly.

The second guide shafts 32 (32) are retained by the fixed funnels 22₁(22₄) at positions inner than the outermost parts of the outermost fixed funnels 22₁(22₄). This allows the second guide shafts 32 (32) to be set on the inner side in the arrangement direction width of the fixed funnels 22₁, 22₂, 22₃, 22₄ arranged in parallel, contributing to reducing the size of the variable air funnel apparatus 20.

As shown in FIGS. 4 and 7, the second guide shafts 32 (32) are positioned inner than the outermost parts of the outermost movable funnels 23₁(23₄) that are smaller in outer diameter than the fixed funnels 22. This allows the second guide shafts 32 (32) to be positioned on the inner side in the arrangement direction width of the movable funnels 22₁, 22₂, 22₃, 22₄ arranged in parallel, further contributing to reducing the size of the variable air funnel apparatus 20.

As shown in FIGS. 4 and 13, the first guide shafts 31 with which the movable funnels 23 slidably engage and the arm members 43 that acts on the first coupling parts 24 to shift the movable funnels 23 are positioned on the inner side of a pair of pillars 41, 41 in the vehicle width direction. Accordingly, when the movable funnels 23 shift due to the swing of the arm members 43, the rotary shaft 42 becomes less prone to having problems such as deflection. Power is transferred effectively.

The central fixed funnels are on the inner side of the pair of pillars in the vehicle width direction and positioned lower than the rotary shaft 42. This contributes to reducing the size of the variable air funnel apparatus 20.

As shown in FIGS. 4 and 7, a pair of pillars 41, 41 is positioned inner than the pair of second guide shafts 32, 32 in the vehicle width direction. This contributes to reducing the size of the variable air funnel apparatus 20. The outermost movable funnels 22₁, 22₄ become less prone to oscillating when shifting by being guided by the second guide shafts 32, 32.

As shown in FIGS. 2, 5, and 6, the first guide shafts 31, the second guide shafts 32, and the rotary shaft 42 are disposed on the side opposite to the air filter 14 relative to the variable air funnels 21. Accordingly, the intake airflow taken from the air filter 14 into the fixed funnels 22 or the movable funnels 23 flows smoothly without any interference with the first guide shafts 31, the second guide shafts 32, and the rotary shaft 42, avoiding a reduction in intake efficiency.

As shown in FIGS. 2 and 3, the second guide shafts 32 are disposed in the unused space inner than the corners of the lateral walls of the air cleaner case 13. The efficient use of the space contributes to reducing the size of the air cleaner case 13.

As shown in FIGS. 2 and 3, the upper ends of the second guide shafts 32 are retained by the upper air cleaner case 13b. This suppresses any oscillation or warpage of the second guide shafts 32 and allows the movable funnels 23 to shift smoothly.

As shown in FIG. 5, the air filter 14 is tilted, having its upper surface oriented toward the variable air funnels 21. The lower side 14az of the upper air filter 14a at a higher position is substantially at the same height as the upstream-end openings of the fixed funnels 22₂, 22₃, whose upstream-end openings are at a higher position. The lower side 14bz of the lower air filter 14b at a lower position is substantially at the same height as the upstream-end openings of the fixed funnels 22₁, 22₄, whose upstream-end openings are at a lower position. Accordingly, when the movable funnels 23 are in the separated position, the upper layer air, having passed through the upper air filter 14a, is taken into the fixed funnels 22₂, 22₃ having their upstream-end openings at a higher position, and lower layer air, having passed through the lower air filter 14b, is taken into the fixed funnels 22₁, 22₄having their upstream-end openings at a lower position.

That is, air from different height layers in the air cleaner case 13 is efficiently taken into the fixed funnels 22 having the upstream-end openings of different heights. This further contributes to improving intake efficiency, and a higher output is expected with a higher engine speed range where the movable funnels 23 are in the separated position.

As shown in FIGS. 2 and 5, out of the fixed funnels 22₁, 22₂, 22₃, 22₄ arranged in parallel, the central fixed funnels 22₂, 22₃are higher than the outer fixed funnels 22₁, 22₄ in height of their upstream-end openings. The lower air filter 14b at a lower position is larger in right-left width. This facilitates the air having passed through the right and left sides of the lower air filter 14b to be taken into the upstream-end openings of the outer fixed funnels having the upstream-end openings at a lower position, improving intake efficiency.

The air having passed through substantially the upper air filter 14a is taken into the upstream-end openings of the central fixed funnels 22₂, 22₃ having their upstream-end openings at a higher position.

Accordingly, the central fixed funnels 22₂, 22_{3,} having their upstream-end openings at a higher position, and the outer fixed funnels 22₁, 22_{4,} having their upstream-end openings at a lower position, can separately cover the upper and lower positions in the air filter, thereby improving intake efficiency.

As shown in FIG. 5, in the ceiling surface 13bi of the upper air cleaner case 13b, the air guiding shape that guides the air having passed through the air filter 14 to the upstream-end openings of the movable funnels 23 in the separated position is formed by the inclined wall 13bc of the upper air cleaner case 13b and the projections 13bd. Accordingly, the air guided by the air guiding shape of the ceiling surface 13bi of the upper air cleaner case 13b flows into the upstream-end openings of the movable funnels 23 in the separated position. The air having passed through the movable funnels 23 joins the intake flow taken into the upstream-end openings of the fixed funnels 22. This further improves intake efficiency when the movable funnels are separated.

The foregoing is the description of the variable air funnel apparatus according to one embodiment of the present invention. The mode of the present invention is not limited to the above embodiment and can be realized variously within the spirit of the present invention.

### REFERENCE SIGNS LIST

1: internal combustion engine

2: crankcase

3: cylinder block

4: cylinder head

5: cylinder head cover

6: oil pan

7: crankshaft

8: transmission

10: throttle body

12: air cleaner

13: air cleaner case

13a: lower air cleaner case

13b: upper air cleaner case

13bb: upper wall

13bc: inclined wall

13bd: projection

13bi: ceiling surface

14: air filter

14a: upper air filter

14az: lower side

14b: lower air filter

14bz: lower side

15: exhaust pipe

16: exhaust muffler

20: variable air funnel apparatus

21: variable air funnels

22: fixed funnel

22f: flange part

22 (22₁, 22₂, 22₃, 22₄): fixed funnel

22a: tube part

22f: flange part

22p: coupling part

22q: retaining bracket

22r: retaining bracket

23 (23₁, 23₂, 23₃, 23₄): movable funnel

23a: tube part

23c: tapered part

23fa: upstream-side flange part

23fb: downstream-side flange part

23d: recess

24: first coupling part

24h: engaging round hole

25: second coupling part

25a: first coupling arm part

25b: second coupling arm part

26: first engaging tube part

26p: opening

27: second engaging tube part

31: first guide shaft

32: second guide shaft

40: supporting bracket

41: pillar

42: rotary shaft

43: arm member

43s: hollow part

50: actuator

51: output shaft

52: first link member

53: second link member

54: third link member

60: fuel injection valve

70 (70₁, 70₂, 70₃, 70₄): movable funnel

70p: upstream-side opening plane

70fa: upstream-side flange part

70r: rib

74: first coupling part

75: second coupling part

76: engaging tube part

77: second engaging tube part

77b: bracket

What is claimed is:

1. A variable air funnel apparatus comprising variable air funnels arranged to be juxtaposed to each other, the variable air funnels including fixed funnels connected to a plurality of intake ports of an internal combustion engine installed in a vehicle, respectively, and movable funnels disposed above the fixed funnels to shift in a central axis direction of the fixed funnels, respectively, wherein
the arranged movable funnels have a separated position where the movable funnels shift together upward in the central axis direction of the fixed funnels to be separated from the fixed funnels, and a coupled position where the movable funnels shift together downward in the central axis direction of the fixed funnels to be coupled to the fixed funnels,
the variable air funnels have a variable intake passage length in which an effective funnel channel length is increased by the movable funnels shifting to the coupled position, and the effective funnel channel length is reduced by the movable funnels shifting to the separated position,
when the movable funnels are in the coupled position, all of the variable air funnels are equal in effective funnel channel length, and
when the movable funnels are in the separated position, at least one of the fixed funnels is different from the other fixed funnels in height of their upstream-end openings, and at least one of the variable air funnels is different in effective funnel channel length from the other variable air funnels.

2. The variable air funnel apparatus according to claim 1, wherein
adjacent ones of the movable funnels are integrally coupled to each other by a coupling part formed at a site where the adjacent movable funnels become close to each other, and
drive of an actuator acts on the coupling part to integrally shift the coupled movable funnels.

3. The variable air funnel apparatus according to claim 2, wherein the movable funnels each have a tapered part, and
the coupling part is provided at the tapered parts.

4. The variable air funnel apparatus according to claim 2, wherein
the fixed funnels retain guide shafts oriented in their central axis direction to oppose the coupling parts, and
the movable funnels slidably engage with and are guided by the guide shafts in shifting.

5. The variable air funnel apparatus according to claim 4, wherein
out of the fixed funnels arranged in parallel in a vehicle width direction, outermost fixed funnels retain second guide shafts, separately from first guide shafts being the guide shafts, at positions inner than outermost parts of the fixed funnels, and
the outermost movable funnels slidably engage with and are guided by the second guide shafts in shifting.

6. The variable air funnel apparatus according to claim 5, wherein the movable funnels are smaller in outer diameter than the fixed funnels, and
the second guide shafts are positioned inner than the outermost parts of the outermost movable funnels.

7. The variable air funnel apparatus according to claim 6, wherein
the outermost fixed funnels support lower ends of pillars that stand upright outer in the vehicle width direction than the first guide shafts,
a rotary shaft rotated by the actuator is horizontally and rotatably suspended between upper ends of a pair of the pillars at a higher position than the fixed funnels, and
an arm member has its basal end fixed to the rotary shaft on an inner side of the pair of pillars in the vehicle width direction, and has its tip engaged with the coupling part.

8. The variable air funnel apparatus according to claim 7, wherein the pair of pillars is positioned inner than the pair of second guide shafts in the vehicle width direction.

9. The variable air funnel apparatus according to claim 8, wherein
in an air cleaner case having its inside divided into a clean side and a dirty side by an air filter, the variable air funnels are provided on the clean side, and
the first guide shafts, the second guide shafts, and the rotary shaft are disposed on the side opposite to the air filter relative to the variable air funnels.

10. The variable air funnel apparatus according to claim 9, wherein the second guide shafts are each disposed on an inner side of a corner of lateral walls of the air cleaner case.

11. The variable air funnel apparatus according to claim 10, wherein
the air cleaner case is structured by a combination of an upper air cleaner case and a lower air cleaner case, and
upper ends of the second guide shafts are retained by the upper air cleaner case.

12. The variable air funnel apparatus according to claim 9, wherein
the air filter is tilted, having its upper surface oriented toward the variable air funnels,
the air filter is made up of two upper and lower units of an upper air filter and a lower air filter,
a lower side of the upper air filter is substantially at a same height as the upstream-end openings of the fixed funnels having their upstream-end openings at a higher position, and
a lower side of the lower air filter is substantially at a same height as the upstream-end openings of the fixed funnels having their upstream-end openings at a lower position.

13. The variable air funnel apparatus according to claim 12, wherein
out of the fixed funnels arranged in parallel, central fixed funnels are higher than outer fixed funnels in height of their upstream-end openings, and
the lower air filter is larger than the upper air filter in right-left width in the vehicle width direction.

14. The variable air funnel apparatus according to claim 13, wherein a ceiling surface of the upper air cleaner case has an air guiding shape that guides air having passed through the air filter to the upstream-end openings of the movable funnels in the separated position.

15. The variable air funnel apparatus according to claim 3, wherein
the fixed funnels retain guide shafts oriented in their central axis direction to oppose the coupling parts, and
the movable funnels slidably engage with and are guided by the guide shafts in shifting.
